(19) United States
(12) Patent Application Publication
(10) Pub. No.: US 2025/0049258 A1
(43) Pub. Date: Feb. 13, 2025

(54) High-Performance Sol-Gel/Peek Composite Coating

(71) Applicant: SEB S.A., Ecully (FR)

(72) Inventors: Barbara Gantillon, Ecully Cedex (FR); Aurelien Dubanchet, Ecully Cedex (FR); Michel Fontaine, Ecully Cedex (FR); Hanlin Liao, Belfort (FR)

(73) Assignee: SEB S.A., Ecully (FR)

(21) Appl. No.: 18/720,413

(22) PCT Filed: Dec. 16, 2022
(86) PCT No.: PCT/FR2022/052411

§ 371 Date: Jun. 14, 2024

(30) Foreign Application Priority Data
Dec. 16, 2021 (FR) 2113650

(51) Int. Cl. A47J 36/02; B05D 1/10; B05D 7/00; C09D 181/02

(52) U.S. Cl. CPC A47J 36/025; B05D 1/10; B05D 7/542; C09D 181/02; B05D 2518/10; B05D 2601/22

(57) ABSTRACT

A culinary item includes a hollow metal cup having a bottom and a sidewall extending up from the bottom, said cup having a concave interior face designed to accept food products and a convex exterior face, said interior face or said bottom being coated with a coating which consists successively, starting from the cup, in a hard sub layer and a sol-gel coating, wherein the hard sub layer takes the form of a discontinuous layer, in that the hard sublayer is porous and in that the hard sublayer is made up of one or more non-fluorinated polymer materials selected from polyetherary I ketones (PEAK) and mixtures thereof, possibly containing hard inorganic fillers, possibly conductive fillers and possibly less than 3 wt % of additives with respect to the weight of the hard sublayer.

### CROSS-REFERENCE TO RELATED APPLICATIONS

The present application is a national phase entry under 35 U.S.C § 371 of International Application No. PCT/FR2022/052411 filed Dec. 16, 2022, which claims priority from French Application No. 2113650 filed Dec. 16, 2021, all of which are hereby incorporated herein by reference.

### BACKGROUND OF THE INVENTION

The present invention applies to the field of sol-gel coatings for cooking surfaces of culinary items and electrical cooking appliances.

The present invention addresses the technical problem of improving the resistance of sol-gel ceramic coatings to scratching and chipping, by producing a sublayer in contact with the metal substrate made from mixtures of thermoplastic and/or thermostable polymers with superior thermo-mechanical properties.

In the field of culinary items, a wide variety of coatings are applied to substrates that are usually made of metal (aluminum, cast aluminum, stainless steel, cast steel, etc.).

More specifically where the interior faces of these items is concerned, coatings made from fluorinated resin of the PTFE type, which are valued for their excellent non-stick properties, have been known for more than 50 years. In recent years, coatings referred to as “ceramic” coatings, based on sol-gel chemistry, have also appeared on the market, offering greater thermal resistance and surface hardness than PTFE coatings, while retaining easy-to-clean properties.

Such coatings are generally obtained by combining silica-based metal alkoxides (silanes) or alumina-based metal alkoxides (aluminates), and are generally applied to metal substrates such as aluminum, cast aluminum, steel, stainless steel, etc.

However, these coatings have limited mechanical resistance properties. Indeed, despite their excellent surface hardness, inorganic or hybrid organic/inorganic ceramic coatings have a “brittle” nature that is more or less marked depending on the extent of the inorganic component.

When subjected to stresses associated with culinary use (knocks from spatulas, forks, mechanical or thermal shocks), this results in the metal splintering, which can be seen by the naked eye and is detrimental to the durability of the coating. The coating is considered fragile by many consumers.

In order to improve the impact resistance of a ceramic coating, patent EP 2 334 444 filed by SEB Group mentions the application of a discontinuous hard base by flame or arc spray technology, prior to sol-gel coating. The final coating is more resistant to impact and scratch testing. Similarly, on the same principle, applying a discontinuous enamel hard base (SEB patent EP 2 334 445) prior to sol-gel coating also produces better mechanical performances. However, scratch resistance remains limited, and this type of hard base requires costly operations: expensive installation and pre-heating of the substrates to above 200° C. for metal/oxide hard bases, and double firing at a temperature higher than 500° C. in the case of enamel, prior to sol-gel coating. Although scratch resistance is improved, it also remains limited.

On the same subject of improving the impact resistance of ceramic sol-gel coatings, patent US20200216669 filed by the Whitford company is also known. The principle involves adding a thermostable polymer (of the PPS, PES, PEEK type, etc.) to the sol-gel formulation in order to reduce the fragility of the ceramic coating. However, the addition is in the form of a filler in the sol-gel matrix, not in the form of a sublayer anchored to the substrate, which leads to limited results in terms of scratch and impact resistance.

Sublayers made from organic polymers are also known in the prior art of culinary items, but are only described to improve the scratch resistance of “soft” coatings made from fluorinated polymers such as PTFE. No mention is made of the possibility of “anchoring” a hard sol-gel coating in these polymeric bases in order to counteract its brittle nature. Furthermore, in most cases, the described method requires double firing, bringing the thermostable polymer above its melting point before cooling and applying the fluorinated layers, which remains very costly.

The polymers used for the sublayer are very often thermoplastics with high thermal resistance and a high melting point, for example polyaryletherketones and, in particular, oxy-1,4-phenylenephenylene-oxy-1,4-phenylene carbonyl 1,4-phenylene or PEEK or phenylenesulfides.

Electrostatic spraying of PEEK in powder form is also possible, and has been described. This technique has the advantage of considerably limiting overspray because the negatively charged metal substrate attracts the positively charged polymer powder. However, this approach requires a highly technical and specialized set-up. The metal substrate must either be connected to the ground throughout the entire process of manufacturing the item in order to prevent delamination of the powder, or must be heated to a temperature higher than the melting point of the polymer. This is therefore a costly technique. Moreover, once again, there is no mention of the possibility of producing a composite with a sol-gel film.

In order to overcome all of these problems and significantly improve the scratch resistance of ceramic coatings, the inventors have demonstrated the possibility of producing a macroporous sublayer with a suitable formulation of hot-melt resin sprayed by thermal spraying onto a metal substrate without pre-heating above 100° C., and then directly applying the layer or layers of liquid ceramic coatings by conventional pneumatic spraying. The presence of reinforcing fillers (alumina, silicon carbide etc.) is also envisaged in the sublayer and/or in the ceramic layers.

Producing this “composite” with strong anchoring of the sol-gel in the matrix of the polymer sublayer results in a final coating with considerably improved mechanical properties.

This coating has excellent adhesion performances as a result of good cohesion between the first layer made from PEEK and the layers of the sol-gel coating.

This invention makes it possible to produce an overall layer (PEEK+sol-gel) or (PEEK/SiC+sol-gel) of significant thickness without causing cracking or crazing of the sol-gel network. Typically, total thickness of more than 60 μm are achieved, which is impossible with conventional sol-gel layers without significant crazing.

It has excellent scratch resistance and mechanical impact resistance.

This invention makes it possible to obtain excellent anti-scratch performances, while retaining a process with a single final firing stage, making it economically feasible to industrialize.

Scratch and impact resistance are greatly improved, meaning that the use of metal utensils will not cause major damage.

The consumer will therefore have a more durable item with a coating that more effectively prevents direct contact between food and the substrate (improved durability in terms of non-stick performances, improved safety in the case of contact with aluminum, improved aesthetics, etc.).

The process, with no pre-heating or high-temperature drying, and with a single final firing stage at a temperature lower than 400° C., is inexpensive and robust.

The coating, which is more robust when subjected to mechanical stress, will therefore also be more durable in terms of non-stick properties, non-staining properties, corrosion resistance, etc.

### SUMMARY OF THE INVENTION

A first object of the invention relates to a culinary item (1) comprising a hollow metal cap (2) that comprises a bottom (211) and a sidewall (212) extending up from the bottom (211), said cap (2) having a concave interior face (21) designed to accept food products and a convex exterior face (22), said interior face (21) or said bottom (211) being coated with a coating (5) which consists successively, starting from the cap (2), of a hard sublayer (3) and a sol-gel coating (4), characterized in that the hard sublayer (3) is in the form of a discontinuous layer, in that said hard sublayer (3) is porous and in that said hard sublayer (3) is made up of one or more non-fluorinated polymer materials chosen from polyaryletherketones (PAEK) and mixtures thereof, optionally hard inorganic fillers, optionally conductive fillers and optionally less than 3% by weight of additives relative to the weight of said hard sublayer.

A second object of the invention relates to a process for manufacturing a culinary item (1), characterized in that it comprises the following steps:
a) a step of providing a metal support (2) comprising two opposing faces;
b) a step of shaping said support (2) to give it the shape of a cap (2), which comprises a bottom (211) and a sidewall (212) extending up from the bottom (211), and thus defining a concave interior face (21) designed to accept food products and a convex exterior face (22), said step b) being carried out either before the step d) of producing the hard sublayer (3), or after the step e) of producing the sol-gel coating (4);
c) optionally, a step of treating the interior face (21) of the support (2) in order to obtain a treated interior face (21) that promotes the adhesion of a hard sublayer (3) on the support (2);
d) a step of producing an adherent hard sublayer (3) on said interior face (21) or on said bottom (211) of the support (2) by thermal spraying of a powder or dispersion of a non-fluorinated polymer material chosen from polyaryletherketones (PAEK), polyetheretherketones (PEEK) and mixtures thereof, optionally hard inorganic fillers, optionally conductive fillers and optionally less than 3% by weight of additives relative to the weight of the hard sublayer (3);
e) a step of producing a sol-gel coating (4) on said hard sublayer (3) formed in step d);
f) a single final firing step.

### Definitions

Within the meaning of the present invention, “sol-gel coating” should be understood to mean a coating synthesized by the sol-gel process from a solution made from precursors in the liquid phase, which is transformed into a solid by a series of chemical reactions (hydrolysis and condensation) at low temperature. The coating obtained in this way may be either organo-mineral or entirely mineral.

Within the meaning of the present invention, “organo-mineral coating” should be understood to mean a coating whose network is essentially inorganic, but which contains organic groups, in particular because of the precursors used and the temperature at which the coating is fired.

Within the meaning of the present invention, “entirely mineral coating” should be understood to mean a coating constituted by an entirely inorganic material free of any organic groups. Such a coating may also be obtained by the sol-gel process with a firing temperature of at least 400° C., or from precursors of the tetraethoxysilane (TEOS) or tetramethoxysilane (TMOS) type with a firing temperature that may be less than 400° C.

Within the meaning of the present invention, the expression “culinary item” should be understood to mean an object intended for cooking. Within the meaning of the present invention, culinary items comprise objects intended to be heated in order to cook or reheat food products carried by the cooking element or contained in the cooking element and electrical cooking appliances.

Within the meaning of the present invention, the expression “object intended to be heated in order to cook or reheat food products carried by the cooking element or contained in the cooking element” should be understood to mean an object that will be heated by an external heating system, such as a cooking hob, and that is capable of transmitting the heat energy supplied by this external heating system to a material or foodstuff in contact with said object. Such an object may, in particular, be a frying pan, a saucepan, a fondue or raclette pan or pot, a stew pot, a wok, a sauté pan, a crêpe pan, a cooking pot, a casserole dish or a cooking mold.

Within the meaning of the present invention, the expression “electrical cooking appliance” should be understood to mean an object intended for cooking, which is configured to produce heat.

Within the meaning of the present invention, the expression “object which is configured to produce heat” should be understood to mean a heating object having its own heating system.

Such an object may in particular be a grill, a plancha, a bowl for a cooking food processor or bread maker, an electric crêpe maker, an electric raclette appliance, an electric fondue appliance, an electric grill, an electric plancha, an electric cooking food processor or a bread maker.

“Equivalent pore diameter” should be understood to mean the diameter of the sphere having the same volume as the pore in question.

“Average equivalent pore diameter” should be understood to mean the average of the equivalent pore diameters.

“Median equivalent pore diameter” should be understood to mean the median of the equivalent pore diameters: 50% of the pores have an equivalent diameter smaller than this diameter and 50% a larger equivalent diameter.

### FIGURES

FIG. 1: Photograph of scratch test, Example 1

FIG. 2: Photograph of scratch test, Comparative example

FIG. 3: SEM/EDX analysis, Example 1

FIG. 4: SEM/EDX analysis, Example 2

FIG. 5: X-ray microtomography analysis, Example 2

FIG. 6: Diagram of a culinary item according to the invention

### DETAILED DESCRIPTION OF THE INVENTION

A first object of the invention relates to a culinary item (1) comprising a hollow metal cap (2) that comprises a bottom (211) and a sidewall (212) extending up from the bottom (211), said cap (2) having a concave interior face (21) designed to accept food products and a convex exterior face (22), said interior face (21) or said bottom (211) being coated with a coating (5) which consists successively, starting from the cap (2), of a hard sublayer (3) and a sol-gel coating (4), characterized in that the hard sublayer (3) is in the form of a discontinuous layer, in that said hard sublayer (3) is porous and in that said hard sublayer (3) is made up of one or more non-fluorinated polymer materials chosen from polyaryletherketones (PAEK) and mixtures thereof, optionally hard inorganic fillers, optionally conductive fillers and optionally less than 3% by weight of additives of said hard sublayer.

“Discontinuous” should be understood to mean a layer that does not have a uniform thickness over the entire surface on which it is deposited. In some places, there may be no covering at all.

Advantageously, the polyaryletherketone or polyaryletherketones (PAEK) are chosen from the group consisting of: polyetherketones (PEK), polyetheretherketones (PEEK), polyetherketoneketones (PEKK), polyetheretherketoneketones (PEEKK) and polyetherketoneetherketoneketones (PEKEKK), in a particularly preferred manner being PEEK.

Preferably, the average thickness of the hard sublayer (3) is greater than 5 μm, or even greater than 15 μm, preferably greater than 30 μm, and more particularly between 20 μm and 50 μm. This average is, for example, the average of at least 10 measurements, and preferably 15 measurements, of the thickness at 10, or respectively 15, random locations. Advantageously, the average equivalent pore diameter in the hard sublayer (3) is greater than 5 μm.

Advantageously, the coating (5) has an overall porosity fraction greater than 8%.

The porosity data of the hard sublayer (3) and of the coating (5), in particular the overall porosity fraction, the average equivalent pore diameter and the median equivalent pore diameter are measured by X-ray microtomography using a synchrotron source.

Preferably, the average equivalent pore diameter is greater than 8 μm, and more preferably greater than 10 μm.

Preferably, the median equivalent pore diameter is greater than 6 μm, even more preferably greater than 7 μm, and more preferably still greater than 8 μm.

Preferably, more than 30%, even more preferably more than 40%, and particularly preferably more than 50% of the pores by number in the hard sublayer (3) have an average equivalent diameter≤10 μm.

Preferably, more than 20%, and even more preferably more than 30% of the pores by number in the hard sublayer (3) have an average equivalent diameter >10 μm and ≤20 μm.

Preferably, more than 60%, even more preferably more than 70%, and in a particularly preferred manner more than 80% of the pores by number in the hard sublayer (3) have an average equivalent diameter≤20 μm.

Preferably, more than 5%, even more preferably more than 7%, and in a particularly preferred manner more than 10% of the pores by number in the hard sublayer (3) have an average equivalent diameter >20 μm and ≤30 μm.

Preferably, pores by number in the hard sublayer (3) have an equivalent pore diameter greater than 30 μm, and preferably at least 1% of the pores by number in the hard sublayer (3) have an equivalent pore diameter greater than 30 μm.

Preferably, the coating (5) has an overall porosity fraction greater than 10%. This refers to the closed porosity.

Preferably, more than 50% of the pore volume of the coating (5) is contained in the hard sublayer (3).

Preferably, the thickness of the coating (5) is between 15 μm and 200 μm, and more preferably still between 50 μm and 200 μm.

Preferably, the additives are chosen from pigments, surfactants and wetting agents. Preferably, said hard sublayer (3) comprises less than 1% by weight of additives.

Preferably, the hard inorganic fillers are particles of silicon carbides or of alumina or of zirconia or of graphite, or of carbon black, or of ceramics, or of one or more metal oxide(s).

In addition to their mechanical reinforcement performances, some hard inorganic fillers such as silicon carbide also have the advantage of being conductive fillers, and therefore provide excellent thermal conductivity.

Adding this type of filler helps improve cooking results, with better heat diffusion from the metal substrate to the food products in contact with the coating.

Preferably, the non-fluorinated polymer material or materials represent more than 50% by weight, and preferably more than 70% by weight of the hard sublayer.

According to one embodiment, the non-fluorinated polymer material(s) represent(s) more than 97% by weight of the hard sublayer, the remainder optionally being made up to 100% by additives.

According to another embodiment, the hard inorganic fillers represent more than 20% by weight, and preferably more than 30% by weight of the hard sublayer.

Preferably, just after thermal spraying, the hard sublayer (3) has surface roughness Ra of between 8 μm and 100 μm, and more preferably of between 10 μm and 60 μm or between 10 μm and 40 μm.

Preferably, the hard sublayer (3) has a developed surface Sdr of between 10% and 100%, and preferably of between 30% and 80%.

Preferably, the sol-gel coating consists of one or more sol-gel layers obtained from a sol-gel (SG) composition comprising at least one metal oxide, preferably a colloidal metal oxide chosen from colloidal silica and/or colloidal alumina and at least one precursor of the metal alkoxide type, preferably an alkoxysilane chosen from the group constituted by methyltrimethoxysilane (MTMS), tetraethoxysilane (TEOS), methyltriethoxysilane (MTES), dimethyldimethoxysilane and mixtures thereof.

Preferably, the sol-gel coating (4) comprises at least one top layer, preferably sol-gel.

Preferably, the cap (2) is a single-layer support made from aluminum or aluminum alloy, cast aluminum, stainless steel, cast steel or copper, or a multilayer support comprising the following layers from the outside towards the inside: ferritic stainless steel/aluminum/austenitic stainless steel or even stainless steel/aluminum/copper/aluminum/austenitic stainless steel, or even a cap of cast aluminum, aluminum or aluminum alloys lined with an outer bottom of stainless steel.

A second object of the invention relates to a process for manufacturing a culinary item (1), characterized in that it comprises the following steps:
a) a step of providing a metal support (2) comprising two opposing faces;
b) a step of shaping said support (2) to give it the shape of a cap (2), which comprises a bottom (211) and a sidewall (212) extending up from the bottom (211), and thus defining a concave interior face (21) designed to accept food products and a convex exterior face (22), said step b) being carried out either before the step d) of producing the hard sublayer (3), or after the step e) of producing the sol-gel coating (4);
c) optionally, a step of treating the interior face (21) of the support (2) in order to obtain a treated interior face (21) that promotes the adhesion of a hard sublayer (3) on the support (2);
d) a step of producing an adherent hard sublayer (3) on said interior face (21) or on said bottom (211) of the support (2) by thermal spraying, on said interior face (21) or said bottom (211), of a powder or dispersion of a non-fluorinated polymer material chosen from polyaryletherketones (PAEK) and mixtures thereof, optionally hard inorganic fillers, optionally conductive fillers and optionally less than 3% by weight of additives relative to the weight of said hard sublayer (3);
e) a step of producing a sol-gel coating (4) on said hard sublayer (3) formed in step d);
f) a single final firing step.

As the name suggests, thermal spraying consists in spraying a powder or a dispersion onto the surface.

Preferably, the metal support (2) in step a) is in the form of a disc.

The process according to the invention does not involve any other firing step apart from that of step f).

Preferably, the thermal spraying is flame spraying or gas dynamic cold spraying (cold spraying).

In flame spraying, the spraying of powder fractions combined with the at least partial melting of the non-fluorinated polymer material explains the discontinuity of the hard sublayer (3).

Preferably, the material intended to be sprayed is a powdery material with a D50 particle size by volume of 5 μm to 60 μm, preferably 10 μm to 35 μm and even more preferably 8 μm to 30 μm.

Preferably, when flame spraying, the step d) of producing the hard sublayer (3) is preceded by a step of preheating said support (2) or said cap (2) to a low temperature, depending on whether the shaping step b) is carried out before the step d) of producing the hard sublayer (3) or after the step e) of producing said sol-gel coating (4). This preheating is carried out at a maximum temperature of 100° C.

Preferably, when cold spraying, the step d) of producing the hard sublayer (3) is preceded by a step of preheating said support (2) or said cap (2) to between 150° C. and 300° C., depending on whether the shaping step b) is carried out before the step d) of producing the hard sublayer (3) or after the step e) of producing said sol-gel coating (4).

Preferably, the firing step (f) is carried out in a furnace at a temperature of between 200° C. and 400° C.

The treatment step c) may be used to roughen the interior face (21), for example by sandblasting, shot blasting, stamping, brushing or chemical etching.

Step e) may be carried out by conventional pneumatic spraying.

### Sol-Gel

The sol-gel coating is an organo-mineral or entirely mineral sol-gel coating. These coatings synthesized by the sol-gel process from precursors of the metal polyalkoxylate type preferably have a hybrid network, generally of silica with grafted alkyl groups. A sol-gel (SG) composition comprises at least one colloidal metal oxide and at least one precursor of the metal alkoxide type.

The metal oxide is preferably a colloidal metal oxide chosen from colloidal silica and/or colloidal alumina.

A metal alkoxide chosen from the following group is preferably used as the precursor:
precursors corresponding to the general formula M₁(OR₁)ₙ,
precursors corresponding to the general formula M₂(OR₂)₍ₙ₋₁₎R₂′, and
precursors corresponding to the general formula M₃(OR₃)₍ₙ₋₂₎R₃′₂, where:
R₁, R₂, R₃ or R₃′ denote an alkyl group,
R₂′ denotes an alkyl or phenyl group,
n is an integer corresponding to the maximum valency of the metals M₁, M₂ or M₃,
M₁ M₂ or M₃ denotes a metal chosen from Si, Zr, Ti, Sn, Al, Ce, V, Nb, Hf, Mg or Ln.

Advantageously, the metal alkoxide of the SG solution is an alkoxysilane.

Alkoxysilanes that may be used in the SG solution of the process of the invention include, in particular, methyltrimethoxysilane (MTMS), tetraethoxysilane (TEOS), methyltriethoxysilane (MTES), dimethyldimethoxysilane, and mixtures thereof.

Preferably, the alkoxysilanes MTES and TEOS will be used, because they have the advantage of not containing methoxy groups. Indeed, the hydrolysis of methoxy groups leads to the formation of methanol in the sol-gel formulation, which, given its toxic classification, requires additional precautions during application. In contrast, the hydrolysis of ethoxy groups generates only ethanol, which has a more favorable classification and is therefore subject to less stringent requirements for use in sol-gel coatings.

The formation of this SG coating consists of mixing an aqueous composition A comprising the colloidal metal oxide and a solution B comprising the metal alkoxide. The mixture is advantageously carried out in a ratio 40% to 75% by weight of the aqueous composition relative to the weight of the sol-gel composition (A+B), such that the quantity of colloidal metal oxide represents 5% to 50% by weight of the sol-gel composition (A+B) in the dry state.

The aqueous composition A may further comprise a solvent, in particular a solvent comprising at least one alcohol.

The aqueous composition A may further comprise at least one silicone oil.

The aqueous composition A may further comprise a pigment.

The aqueous composition A may further comprise a mineral filler.

The aqueous composition A may also comprise fumed silica, the function of which is to regulate the viscosity of the sol-gel composition and/or the gloss of the dry coating.

The aqueous composition A typically comprises, for a primer layer:
i) 5% to 50% by weight relative to the total weight of the aqueous composition A of at least one colloidal metal oxide,
ii) 0% to 20% by weight relative to the weight of the composition A of a solvent comprising at least one alcohol,
iii) optionally, 0.05% to 3% by weight relative to the total weight of said aqueous composition A of at least one silicone oil,
iv) 5% to 30% of pigment,
v) 2% to 30% of mineral filler.

The aqueous composition A typically comprises, for a top layer:
i) 5% to 50% by weight relative to the total weight of the aqueous composition A of at least one colloidal metal oxide,
ii) 0% to 20% by weight relative to the weight of the composition A of a solvent comprising at least one alcohol,
iii) optionally, 0.05% to 3% by weight relative to the total weight of said aqueous composition A of at least one silicone oil,
iv) 0.1% to 1% of metal flakes.

The solution B may further comprise a Bronsted or Lewis acid. Advantageously, the precursor of the metal alkoxide type of the solution B is mixed with an organic or mineral Lewis acid which represents 0.01% to 10% by weight of the total weight of the solution B.

Specific examples of acids that can be used for the mixture with the metal alkoxide precursor are acetic acid, citric acid, ethyl acetoacetate, hydrochloric acid or formic acid.

The solution B may further comprise a solvent, in particular a solvent comprising at least one alcohol.

The solution B may further comprise at least one silicone oil.

The solution B may further comprise metal flakes.

According to one advantageous embodiment of the process of the invention, the solution B may comprise a mixture of one of the alkoxysilanes as defined above and an aluminum alcoholate.

### EXAMPLES AND RESULTS

### Example 1: Porous PEEK Sublayer, White Sol-Gel Primer and Hydrophobic Finish, on Aluminum

### Procedure

### —Raw Materials

PEEK (polyetheretherketone) is manufactured and sold under the brand name VICTREX VICOTE PEEK® 703 with a D50 diameter of 25 μm, a glass transition temperature of 143° C. and a melting temperature of 343° C.
Equipment: Castolin Eutectic CastoDyn DS 8000 flame spray torch with flame nozzle reference Castolin Eutectic module SSM 40.
The speed of movement of the torch is 150 mm/sec to 200 mm/sec
Sulzer Metco twin powder feeder, flow rate of the powder mixture: varies from 2 g/min to 7 g/min
Thickness of the sublayer: between 10 μm and 50 μm
Propellant gas: compressed air
Combustible gas: acetylene, varies from 10 l/min to 16 l/min and acetylene pressure varies from 0.5 bar to 1 bar
Combustible gas: oxygen, varies from 10 l/min to 20.0 l/min and oxygen pressure varies from 3 bar to 5 bar
The temperature of the support during the application of the hard base: greater than or equal to room temperature (of the order of 20° C. to 250° C.)
Torch-to-part application distance, between 10 cm and 20 cm
Rotational speed of the parts, between 400 rpm and 800 rpm

The flame spraying or thermal spraying method is a method for manufacturing a culinary item, characterized in that it comprises the following steps:
a) a step of providing a metal support in the form of a disc, comprising two opposing faces;
b) a step of shaping said support to give it the shape of a cap, which comprises a bottom and a sidewall extending up from the bottom, and thus defining a concave interior face designed to accept food products and a convex exterior face;
c) optionally, a step of treating the interior face of the support in order to obtain a treated interior face that promotes the adhesion of a hard base on the support;
d) a step of producing an adherent hard base on said interior face of the support;
e) a step of producing a coating on said hard base formed in step d);
said method being characterized in that the step d) of producing the hard base comprises thermal spraying, on said interior face, of a ceramic and/or polymer material in powder form, so as to form, on said interior face of the cap, a layer that is at least discontinuous, the discontinuous part being in the form of a partially melted and crystallized surface dispersion, distributed in a substantially uniform manner over said interior face, and in that the step b) of shaping the support is carried out either before the step d) of producing the hard base or after the step e) of producing the ceramic coating.

The ceramic coating, both primer and finish, is prepared using a two-component system: part A and part B respectively:
Part A includes the pigments (in the case of a primer), the fillers and the additives;
Part B includes the reactive silanes and the catalyst.

White primer

| Components | Part | Mass |
|---|---|---|
| Colloidal silica (30%) | A | 27.5 |
| Distilled water | A | 5 |
| Isopropanol | A | 3 |
| TiO2 white pigment | A | 13 |
| Alumina | A | 14.5 |
| PDMS silicone oil | A | 1.1 |
| MTES (methyltriethoxysilane) | B | 35.5 |
| Formic acid | B | 0.4 |
| TOTAL | | 100 |

Hydrophobic finish

| Components | Part | Mass |
|---|---|---|
| Colloidal silica (40%) | A | 29.8 |
| Distilled water | A | 8.2 |
| Acetic acid | A | 1.3 |
| Isopropanol | A | 5 |
| PDMS silicone oil | A | 1.3 |
| MTES (methyltriethoxysilane) | B | 39 |
| Butylglycol | B | 14 |
| Wetting agent | B | 0.9 |
| Flakes | B | 0.5 |
| TOTAL | | 100 |

The method for formulating the primer and the finish is as follows:

The parts A are prepared by successively introducing the colloidal silica, the isopropanol and, if applicable, the pigment, the alumina or the additives into a planetary mixer in order to obtain a homogeneous liquid. This mixing can also be carried out using a shearing stirrer blade.

The parts B are prepared separately by mixing the silanes with the organic acid, and the wetting agent, the solvent and the flakes in the case of the finish.

These two parts may be stored separately for six months.

The parts A and B are then mixed using a high-speed stirrer for three hours to allow hydrolysis of the silane. The mixture is then left at room temperature for 24 hours before application. The service life of this formulation is at least 48 hours.

The primer mixture is then filtered with a 60-micron filter before being applied by spraying onto the PEEK sublayer. The overall thickness of the PEEK/sol-gel primer composite is 80 microns.

This primer layer is then optionally dried at 50° C. for one minute before cooling to 30° C.

The finish mixture will be filtered with a 110-micron filter and applied by spraying onto the primer layer. Its dry thickness will be 5 microns.

Finally, the PEEK/sol-gel composite coating is fired at 250° C. for 30 minutes.

### Example 2: Porous PEEK Polymer Sublayer Containing Silicon Carbide, White Sol-Gel Primer and Hydrophobic Finish, on Aluminum

### Procedure

### —Raw Materials

PEEK (polyetheretherketone) is manufactured and sold under the brand name VICTREX VICOTE PEEK® 703 with a D50 diameter of 25 μm, a glass transition temperature of 143° C. and a melting temperature of 343° C.
Silicon carbide (brand name SIKA ABR I F500) with a D50 diameter=12.8 μm
Equipment: Castolin Eutectic CastoDyn DS 8000 flame spray torch with flame nozzle reference Castolin Eutectic module SSM 40.
The speed of movement of the torch is 150 mm/sec to 200 mm/sec
Sulzer Metco twin powder feeder, flow rate of the powder mixture: varies from 2 g/min to 7 g/min
Thickness of the sublayer: between 10 μm and 50 μm
Propellant gas: compressed air
Combustible gas: acetylene, varies from 10 l/min to 16 l/min and acetylene pressure varies from 0.5 bar to 1 bar
Combustible gas: oxygen, varies from 10 l/min to 20.0 l/min and oxygen pressure varies from 3 bar to 5 bar
The temperature of the support during the application of the hard base: greater than or equal to room temperature (of the order of 20° C. to 250° C.)
Torch-to-part application distance, between 10 cm and 20 cm
Rotational speed of the parts, between 400 rpm and 800 rpm

The PEEK/SiC ratio is 70/30.

The two-layer sol-gel coating is then prepared and sprayed in the same way as in example 1.

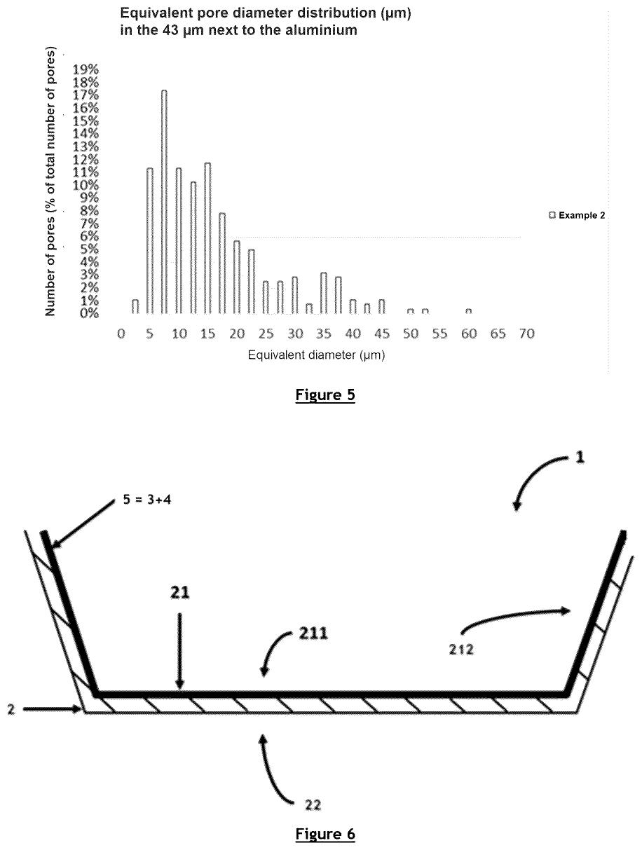

FIG. 5:

The average equivalent pore diameter of the hard sublayer is 14.9 μm (measured by X-ray microtomography within 43 μm of the metal surface).

### Example 3: Porous PEEK Polymer Sublayer Containing Silicon Carbide/Cold Spray Process

The cold spray method makes it possible to obtain uniform, solid, thick deposits on the surfaces of substrates to be coated. The cold spray principle is based on the high-speed spraying of powder particles, which, upon colliding with the substrate, undergo physical deformation. A pressurized gas stream (from 0.1 MPa to 5 MPa) is heated (from 25° C. to 1,000° C.) then injected into a de Laval (convergent-divergent) nozzle. In this nozzle, the gas is accelerated to supersonic speeds. The powder is injected into the gas stream upstream or downstream of the nozzle. The gas stream carries the powder particles at high speed to the substrate. If their kinetic energy is sufficient, both the particles and the substrate will deform on impact. Under deformation, the particles adhere to the substrate via mechanical bonds and, depending on their nature, via chemical or metallurgical bonds. Subsequent particles stack up on the previous layers, forming a deposit of greater or lesser thickness. The sprayed particles remain in a solid state.

### Description of the Spraying Device:

The cold spray equipment used is a CGT kinetics 3000 model coupled with a PF4000 powder feeder. The pressure range is from 1 MPa to 3 MPa and the temperature range from 300° C. to 500° C.

The gas used is nitrogen. Spraying is carried out with an “MOC24” tungsten carbide nozzle with a diameter <1 mm, fastened perpendicular to the samples and kept at 80 mm from the substrates. An illumination speed of 300 mm·s−1 with surfacing pitch of 1 mm.

A cap made of aluminum of thickness of 45/10^{th} is degreased and then shot blasted or sandblasted before undergoing an appropriate surface treatment to eliminate organic contaminants. The roughness has an Ra of the order of 5 μm, the surface condition is described above. This disc is preheated to a maximum temperature of 260° C. and used to apply a mixture of PEEK and silicon carbide powders in a 70/30 mass ratio, using a cold spray method (gas dynamic cold spraying).

PEEK (polyetheretherketone) is manufactured and sold under the brand name VICTREX VICOTE PEEK® 703 with a D50 volume diameter of 25 μm.

The cold spray method is used to obtain a discontinuous deposit of the above powder and in order to deposit a thickness of this layer of the order of 50 μm.

This disc prepared as such is successively covered with a hard layer and sol-gel top layers as described above.

After a single firing operation at 250° C. for 30 minutes, the coating has a surface that is slightly rough to the touch and does not crack.

### Comparative Example: White Sol-Gel Primer and Hydrophobic Finish, without PEEK Sublayer, on Aluminum

In this comparative example, no polymer sublayer is applied to the sandblasted aluminum substrate, but the same sol-gel primer and finish layers as in examples 1 and 2 are applied directly.

The formulation, coating and final firing processes are also the same as in example 1.

### Test Results and SEM/EDX Characterization

### Scratch Test:

Using a Rockwell diamond tip with a 200 μm radius, a progressive load is applied to the coating, increasing the force applied from 0 Newtons to 20 Newtons. The trace of the scratch is then observed under an optical microscope. The delamination value recorded for the coating corresponds to the force at which a clear fracture is observed in the film down to the metal. The parameters of speed of increase of load and speed of movement of the tip are kept constant in all of the tests.

Five scratches are made for each sample, and the average of the 5 values of delamination to the metal is retained.

The results of the 3 configurations are indicated below:

| Tested configuration | Scratch to the metal (in N) |
|---|---|
| Example 1 (PEEK/sol-gel) | 19.55 |
| Example 2 (PEEK SiC/sol-gel) | >20 |
| Comparative example: Sol-gel alone | 7.88 |

The improvement in scratch resistance is very clear.

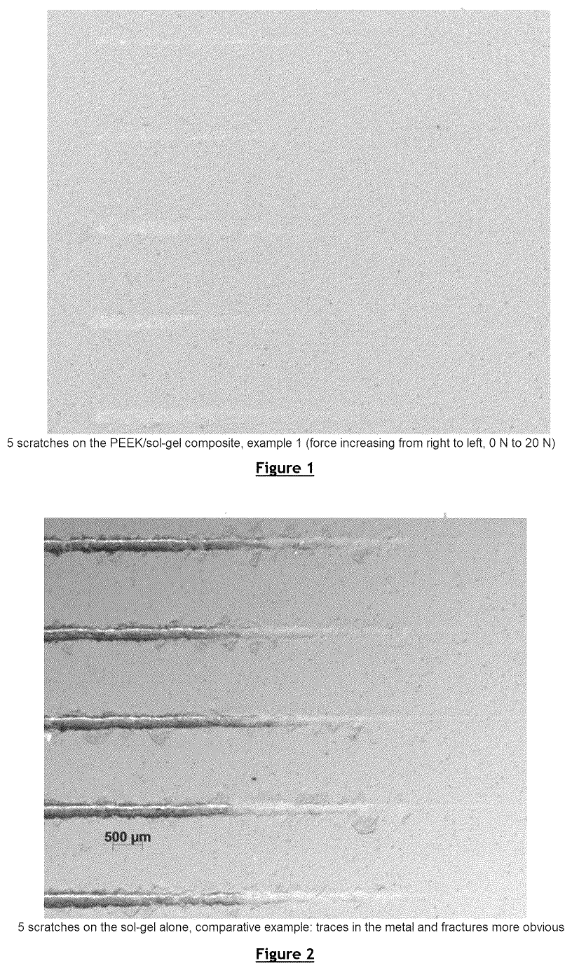

The results can also be seen in FIGS. 1 (Example 1) and 2 (Comparative example).

### Mechanical Impact Test (Ball Impact):

Impact Resistance of Non-Stick Coating Assessed by Erichsen Test in Accordance with ISO 6272.

This is an impact test that involves dropping a 2 kg ball from a height of 50 cm. For testing, aluminum or stainless steel wafers are used, one side of which is coated with a two-layer sol-gel coating according to the present invention. The wafers are all identical to each other (in terms of thickness and the nature of the alloy) in order to have constant deformation for all of the tests.

This test involves directly impacting the deposited sol-gel coating on the coated side of a wafer (internal deep drawing test), and impacting the side opposite that coated with the sol-gel coating of another wafer (external deep drawing test).

Once the impacts have been carried out, the coated surface is visually inspected.

The impact resistance of the coating is assessed based on the following visual scale, which is established after an impact directly on the coating (internal deep drawing test), and on the opposite side to that which is coated (external deep drawing test).
A rating of 0 is given if the following is observed:

### For the Internal Deep Drawing Test:

At the point of impact, complete delamination of the coating over the entire deformed area of the interior face, manifested by the appearance of a “white” zone at the point of impact (corresponding to a portion of metal surface without coating), in the form of a disc with a diameter of the order of 25 mm.

### For the External Deep Drawing Test:

Also complete delamination of the coating over a large area of the deformed interior face, manifested by the appearance of a “white” zone at the point of impact (corresponding to a portion of metal surface without coating), this zone being in the form of a disc with a diameter of at least 10 mm.
A rating of 1 is given if the following is observed:

### For the Internal Deep Drawing Test:

At the point of impact, almost complete delamination of the coating over a large area of the deformed interior face, this delamination being manifested by the appearance of a nearly “white” zone at the point of impact (corresponding to a portion of metal surface without coating), this zone being in the form of a disc with a diameter of the order of 20 mm.

### For the External Deep Drawing Test:

An almost complete delamination of the coating over a medium-sized area of the deformed interior face, which is manifested by the appearance of a “white” zone with no coating at the point of impact, in the form of a disc with a diameter of the order of 10 mm.
A rating of 2 is given if the following is observed:

### For the Internal Deep Drawing Test:

At the point of impact, almost complete delamination of the coating over a medium-sized area of the coated interior face, which is manifested by the appearance of a “white” zone with no coating at the point of impact, in the form of a disc having a diameter of the order of 10 mm.

### For the External Deep Drawing Test:

At the point of impact, a white zone in the form of a disc having a diameter of the order of 10 mm, in which there are large splinters extending to the metal surface of the support, with a relatively high density of splinters.
A rating of 3 is given if the following is observed:

### For the Internal Deep Drawing Test:

At the point of impact, a central zone in which there are large splinters revealing the metal.

### For the External Deep Drawing Test:

At the point of impact, a white surface in the form of a disc having a diameter of less than 10 mm, and in which there are fine splinters extending to the metal, with a moderately high density.
A rating of 4 is given if the following is observed:

### For the Internal Deep Drawing Test:

At the point of impact, a zone in the form of a disc of small diameter, in which there are fine splinters extending to the metal, with a fairly low density.
For the external deep drawing test, a few pitting marks down to the metal, located at the point of impact.
Finally, a rating of 5 is given if the following is observed:

### For the Internal Deep Drawing Test:

At the point of impact, a faint halo slightly lighter than the coating.

### For the External Deep Drawing Test:

No change to the appearance of the coating.
The higher the obtained rating, the better the impact resistance of the coating.

### The Results are Described Below:

Impact resistance

| | | Internal | External |
|---|---|---|---|
| | | deep | deep |
| Example | Coating configuration | drawing/5 | drawing/5 |
| 1 | PEEK/sol-gel | 4 | 4 |
| 2 | PEEK SiC/sol-gel | 4 | 4 |
| Comparative | Sol-gel | 2 | 2 |

As for the scratch test, the improvement in impact resistance is significant with this PEEK/sol-gel composite invention.

### SEM/EDX Characterizations:

The SEM is a multi-purpose, multi-functional piece of equipment that provides images of the surface structure and morphology of the material with a resolution of a few nm and a very high depth of field; it also provides qualitative (BSE) and quantitative (EDX, lateral resolution around 1 μm) chemical information.

EDX is a technique in which the X-rays generated by the interaction between the electron beam and the sample are analyzed to give an elemental composition of the sample. An EDX spectrum comprises peaks that correspond to the characteristic radiation of a specific element. A quantitative chemical characterization of the sample is deduced from the EDX spectrum.

The SEM/EDX analysis technique combines topographic surface analysis using a scanning electron microscope (SEM) with chemical analysis using energy-dispersive X-ray spectroscopy (EDX).

The principle of SEM is based on the detection of secondary electrons. A beam of electrons (referred to as primary electrons) comes into contact with the sample surface. When they collide with atoms on the surface, the primary electrons can give up energy to electrons in the upper layers of these atoms. These electrons are then ejected and are referred to as secondary electrons. Analyzing these electrons, which come from the surface layers, provides information on topography. When the primary electrons collide with the atoms, the latter can enter an excited state. When they return to a stable state, they emit X-rays whose wavelength is characteristic of the nature of the atom. Therefore, analyzing these X-rays provides information on the chemical nature of the sample.

Physico-chemical analysis of the surface by means of SEM/EDX analysis also shows the macroporosity of this PEEK or PEEK/SiC sublayer.

A layer with very high porosity is obtained, owing to an accumulation of partially melted PEEK particles.

The spray-coated sol-gel coating is impregnated into the macroporosity of the sublayer, creating a composite after crosslinking of the sol-gel network, without the need for post-treatment (hot pressing, etc.).

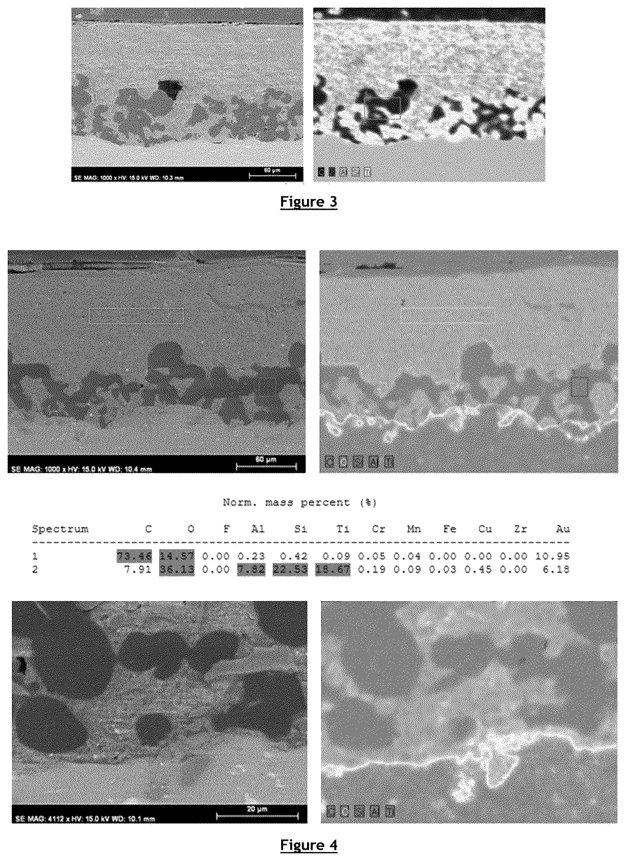

The sol-gel network interpenetrates with the macromolecular chains of the PEEK, possibly in the presence of silicon carbide fillers, creating a dense network with excellent mechanical properties due to the anchoring of the sol-gel in the porous PEEK or PEEK/SiC matrix (FIG. 3).

### Porosity Evaluation Tests Using X-Ray Microtomography Analysis

X-ray microtomography is a powerful, non-destructive testing technique that generates a magnified 3D image of a sample. Its operation is based on the same physical principles as medical scanning, and provides better spatial resolution, to less than a micrometer. This technique consists in acquiring a large number of radiographic projections of a sample from multiple angles to digitally reconstruct a 3D map of the phases that make up the sample.

X-ray radiography involves passing an X-ray beam through a sample and measuring the spatial distribution of the beam's intensity when it exits the sample, on a detector.

Various X-ray sources can be used for X-ray microtomography, including X-ray tubes and synchrotrons. These two types of sources have different characteristics, which influence microtomographic acquisitions.

For the analyses in question, the source used is the synchrotron, which, unlike X-ray tubes, emits a parallel X-ray beam. The radiographic projections are enlarged by the detector. This incorporates an optical system that can be adjusted to select the desired pixel size. It is therefore not necessary to bring the sample closer to the source in order to improve acquisition resolution; this helps overcome limitations on the size of objects and offers the possibility of sub-μm pixel sizes.

The X-rays used in radiography have sufficient energy to pass through most materials; they are poorly absorbed by lightweight elements and can pass through considerable thicknesses of material. When an X-ray beam passes through a sample, it is affected by various physical mechanisms that result in a decrease in its intensity until it leaves the sample. This attenuation is proportional to the thickness and attenuation coefficient of the phases through which it passes. Therefore, each unitary sensor in the detector measures an intensity that depends on the path taken by the beam through the material. These local intensity measurements are then digitized and converted to form a grayscale image referred to as a radiograph or radiographic projection.

Radiographic systems can also generate an enlargement of the projected image, using the geometry of the beam emitted by the X-ray source or via the detection system.

Low-density regions correspond to low gray levels (close to black), while high-density regions correspond to high gray levels (close to white). These contrasting gray levels enable phases of different densities to be distinguished.

The distribution of gray levels in microtomography data can be displayed on a histogram. In particular, the histogram of gray levels provides information on the volume fractions of the different phases of the sample.

1-25. (canceled)

26. A culinary item comprising a hollow metal cap that comprises a bottom and a sidewall extending up from the bottom, said cap having a concave interior face designed to accept food products and a convex exterior face, said interior face or said bottom being coated with a coating which consists successively, starting from the cap, of a hard sublayer and
a sol-gel coating, wherein the hard sublayer is in the form of a discontinuous layer, and wherein said hard sublayer is porous, presenting pores, and wherein said hard sublayer is made up of one or more non-fluorinated polymer materials chosen from polyaryletherketones (PAEK) and mixtures thereof.

27. The culinary item as claimed in claim 26, wherein the hard sublayer further comprises fillers selected from hard inorganic fillers, conductive fillers and a combination thereof.

28. The culinary item as claimed in claim 26, wherein the hard sublayer comprises less than 3% by weight of additives relative to the weight of said hard sublayer.

29. The culinary item as claimed in claim 26, wherein the pores present an average equivalent pore diameter in the hard sublayer (3) that is greater than 5 μm and wherein the coating has an overall porosity fraction greater than 8%.

30. The culinary item as claimed in claim 29, wherein the average equivalent pore diameter in the hard sublayer is greater than 8 μm.

31. The culinary item as claimed in claim 26, wherein the pores present a median equivalent pore diameter in the hard sublayer that is greater than 6 μm.

32. The culinary item as claimed in claim 26, wherein the hard sublayer presents pores having an equivalent pore diameter that is greater than 30 μm.

33. The culinary item as claimed in claim 26, wherein at least 1% of the pores by number in the hard sublayer have an equivalent pore diameter that is greater than 30 μm.

34. The culinary item as claimed in claim 29, having an overall porosity fraction greater than 10% in the coating.

35. The culinary item as claimed in claim 26, wherein more than 50% of the pores' volume of the coating is contained in the hard sublayer.

36. The culinary item as claimed in claim 26, wherein the average thickness of the hard sublayer is greater than 5 μm.

37. The culinary item as claimed in claim 26, wherein the coating presents a thickness of between 15 μm and 200 μm.

38. The culinary item as claimed in claim 28, wherein that the additives are selected from the group consisting of pigments, surfactants and wetting agents.

39. The culinary item as claimed in claim 27, wherein the hard inorganic fillers are selected from the group consisting of silicon carbides particles, alumina particles, zirconia particles, graphite particles, carbon black particles, ceramic particles, and particles of one or more metal oxides.

40. The culinary item as claimed in any claim 26, wherein the non-fluorinated polymer material or materials represent more than 50% by weight by weight of the hard sublayer.

41. The culinary item as claimed in claim 40, wherein the non-fluorinated polymer material or materials represent more than 97% by weight of the hard sublayer.

42. The culinary item according to claim 27, wherein the hard inorganic fillers represent more than 20% by weight of the hard sublayer.

43. The culinary item as claimed in claim 26, wherein the hard sublayer (3) has surface roughness Ra of between 8 μm and 100 μm.

44. The culinary item as claimed in claim 26, wherein the non-fluorinated polymer material of said hard sublayer is PEEK.

45. The culinary item as claimed in claim 26, wherein the sol-gel coating consists of one or more sol-gel layers obtained from a sol-gel composition comprising:
at least one metal oxide,
a colloidal metal oxide selected from the group consisting of colloidal silica, colloidal alumina, and mixtures thereof, and
at least one precursor of the metal alkoxide type, an alkoxysilane selected from the group consisting of methyltrimethoxysilane (MTMS), tetraethoxysilane (TEOS), methyltriethoxysilane (MTES), dimethyldimethoxysilane and mixtures thereof.

46. The culinary item as claimed in claim 26, wherein the sol-gel coating comprises at least one top layer, preferably sol-gel.

47. The culinary item as claimed in claim 26, wherein the cap is:
a single-layer support made from aluminum or aluminum alloy, cast aluminum, stainless steel, cast steel or copper, or
a multilayer support comprising the following layers from the outside towards the inside:
ferritic stainless steel/aluminum/austenitic stainless steel, or
stainless steel/aluminum/copper/aluminum/austenitic stainless steel, or
a cap of cast aluminum, aluminum or aluminum alloys lined with an outer bottom of stainless steel.

48. A process for manufacturing a culinary item, comprising the following steps:
a) a step of providing a metal support comprising two opposing faces;
b) a step of shaping said support to give it the shape of a cap, which comprises a bottom and a sidewall extending up from the bottom, and thus defining a concave interior face designed to accept food products and a convex exterior face, said step b) being carried out either before the step d) of producing the hard sublayer, or after the step e) of producing the sol-gel coating;
c) optionally, a step of treating the interior face of the support in order to obtain a treated interior face that promotes the adhesion of a hard sublayer on the support;
d) a step of producing an adherent hard sublayer on said interior face or on said bottom of the support by thermal spraying of a powder or dispersion of a non-fluorinated polymer material chosen from polyaryletherketones (PAEK), polyetheretherketones (PEEK) and mixtures thereof;
e) a step of producing a sol-gel coating on said hard sublayer formed in step d);
f) a single final firing step.

49. The process as claimed in claim 48, wherein the thermal spraying is flame spraying or gas dynamic cold spraying.

50. The process as claimed in claim 49, wherein the material intended to be sprayed is a powdery material with a D50 particle size by volume of 5 μm to 60 μm.

51. The process as claimed in claim 49, wherein the thermal spraying is flame spraying and the step d) of producing the hard sublayer is preceded by a step of preheating said support or said cap to less than 100° C., depending on whether the shaping step b) is carried out before the step d) of producing the hard sublayer or after the step e) of producing the sol-gel coating.

52. The process as claimed in claim 49, wherein the thermal spraying is gas dynamic cold spraying and the step d) of producing the hard sublayer is preceded by a step of preheating said support or said cap to between 150° C. and 300° C., depending on whether the shaping step b) is carried out before the step d) of producing the hard sublayer or after the step e) of producing the sol-gel coating.

53. The process as claimed in claim 48, wherein the firing step (f) is carried out in a furnace at a temperature of between 200° C. and 400° C.
